(19) United States
(12) Patent Application Publication
(10) Pub. No.: US 2024/0378691 A1
(43) Pub. Date: Nov. 14, 2024

(54) INFORMATION PROCESSING DEVICE, INFORMATION PROCESSING METHOD, AND INFORMATION PROCESSING SYSTEM

(71) Applicant: TOYOTA BOSHOKU KABUSHIKI KAISHA, Aichi (JP)

(72) Inventor: Tokuyuki NISHIKAWA, Aichi (JP)

(73) Assignee: TOYOTA BOSHOKU KABUSHIKI KAISHA, Aichi (JP)

(21) Appl. No.: 18/648,657

(22) Filed: Apr. 29, 2024

(30) Foreign Application Priority Data
May 10, 2023 (JP) 2023-077963

(51) Int. Cl. G06Q 50/47

(52) U.S. Cl. CPC G06Q 50/47

(57) ABSTRACT

A user terminal is communicably connected with at least one module that is detachably mounted to a vehicle or that is detachably mounted to the vehicle and has a function which is able to be, while the at least one module is mounted to the vehicle, activated and deactivated depending on whether or not the at least one module is energized, the user terminal being configured to present, to a user of the vehicle, a service available by the at least one module.

This Nonprovisional application claims priority under 35 U.S.C. § 119 on Patent Application No. 2023-077963 filed in Japan on May 10, 2023, the entire contents of which are hereby incorporated by reference.

### TECHNICAL FIELD

The present disclosure relates to an information processing device, an information processing method, and an information processing system.

### BACKGROUND ART

Patent Literature 1 discloses causing a stimulus output device to output stimulus for relaxing a user, in accordance with a body information detected by a detection device.

### CITATION LIST

### Patent Literature

### [Patent Literature 1]

Japanese Patent Application Publication Tokukai No. 2021-67620

### SUMMARY OF INVENTION

### Technical Problem

However, Patent Literature 1 does not disclose, for example, detachment of the detection device and the stimulus output device from a vehicle or replacement with other devices, and thus the service available for a user is limited.

It is an object of an aspect of the present disclosure to provide a variety of services.

### Solution to Problem

In order to solve the foregoing problem, an information processing device in accordance with an aspect of the present disclosure is an information processing device including a controller, the controller being communicably connected with at least one module that is detachably mounted to a vehicle or that is detachably mounted to the vehicle and has a function which is able to be, while the at least one module is mounted to the vehicle, activated and deactivated depending on whether or not the at least one module is energized, the controller being configured to present, to a user of the vehicle, a service available by the at least one module.

In order to solve the foregoing problem, an information processing method in accordance with an aspect of the present disclosure is an information processing method used for an information processing device including a controller, the controller being communicably connected with at least one module that is detachably mounted to a vehicle or that is detachably mounted to the vehicle and has a function which is able to be, while the at least one module is mounted to the vehicle, activated and deactivated depending on whether or not the at least one module is energized, the method including presenting, to a user of the vehicle, a service available by the at least one module.

In order to solve the foregoing problem, a storage medium in accordance with an aspect of the present disclosure is a computer-readable storage medium storing an information processing program used for an information processing device including a controller, the controller being communicably connected with at least one module that is detachably mounted to a vehicle or that is detachably mounted to the vehicle and has a function which is able to be, while the at least one module is mounted to the vehicle, activated and deactivated depending on whether or not the at least one module is energized, the information processing program being configured to cause a computer to carry out a process of presenting, to a user of the vehicle, a service available by the at least one module.

In order to solve the foregoing problem, an information processing system in accordance with an aspect of the present disclosure includes: an information processing device including a controller; and at least one module that is detachably mounted to a vehicle or that is detachably mounted to the vehicle and has a function which is able to be, while the at least one module is mounted to the vehicle, activated and deactivated depending on whether or not the at least one module is energized, the controller being communicably connected with the at least one module, the controller being configured to present, to a user of the vehicle, a service available by the at least one module.

The information processing device in accordance with each aspect of the present disclosure may be realized by a computer. In this case, the scope of the present disclosure also includes a control program causing the information processing device to be realized by the computer by causing the computer to operate as each section (software component) of the information processing device; and a computer-readable storage medium storing the control program.

### Advantageous Effects of Invention

According to an aspect of the present disclosure, it is possible to provide a variety of services.

### BRIEF DESCRIPTION OF DRAWINGS

FIG. 1 is a view schematically illustrating a configuration of an example of an in-vehicle service providing system in accordance with Embodiment 1 of the present disclosure.

FIG. 2 is a block diagram illustrating a hardware configuration of a user terminal.

FIG. 3 is a functional block diagram illustrating a CPU of the user terminal.

FIG. 4 is a flowchart illustrating an example of a flow of a process performed by the in-vehicle service providing system.

FIG. 5 is a view illustrating an example of notification displayed on a display of the user terminal.

FIG. 6 is a flowchart illustrating an example of a method for controlling modules.

FIG. 7 is a view for explaining services available by combination of the modules.

FIG. 8 is a view illustrating other combinations for refreshing services.

FIG. 9 is a functional block diagram illustrating a CPU in accordance with a variation of Embodiment 1.

FIG. 10 is a view illustrating a service that becomes available by adding a new module.

FIG. 11 is block diagram illustrating a hardware configuration of a control device in accordance with Embodiment 2 of the present disclosure.

FIG. 12 is a view schematically illustrating a configuration of an example of an in-vehicle service providing system in accordance with Embodiment 3 of the present disclosure.

FIG. 13 is a view illustrating one example of services available by combinations of an existing device and modules.

### DESCRIPTION OF EMBODIMENTS

### Embodiment 1

The following description will discuss an in-vehicle service providing system in accordance with Embodiment 1 of the present disclosure in detail with reference to the drawings. The same parts in the drawings are given the same reference numerals, and descriptions thereof will be omitted.

### (Configuration of In-vehicle Service Providing System)

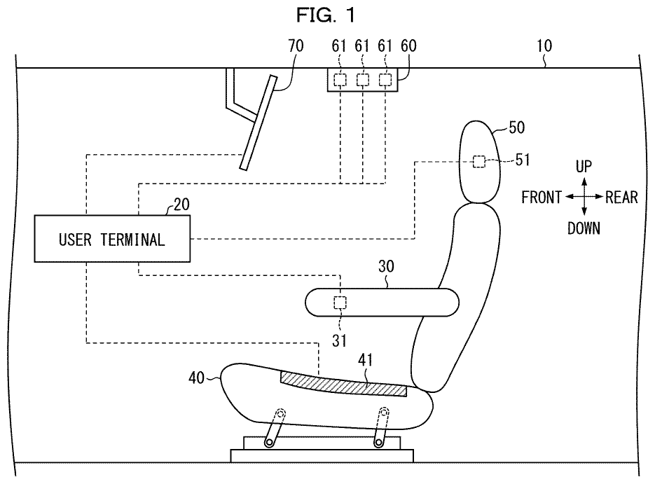

FIG. 1 is a view schematically illustrating a configuration of an example of an in-vehicle service providing system. As illustrated in FIG. 1, the in-vehicle service providing system includes modules mounted to a vehicle 10 and a user terminal 20. The modules will be described later in detail. The single vehicle 10 is present in FIG. 1 but is not be limited to this. The in-vehicle service providing system may include two or more vehicles. In addition, the single user terminal 20 is present in FIG. 1 but is not limited to this. The in-vehicle service providing system may include two or more user terminals.

In the present embodiment, descriptions are based on the assumption that the vehicle 10 is a vehicle used for a ridesharing service. However, the vehicle 10 is not limited to this and may be a vehicle used as a private vehicle. To the vehicle 10, a plurality of modules are mounted which are detachable from the vehicle 10. Here, the “modules” refer to components which each have a predetermined function and which can be easily added or replaced in the vehicle 10. Here, the expression “can be easily added or replaced” means that, for example, an operator in charge of servicing for the vehicle 10 in a dealer or an owner of the vehicle 10 can perform the addition or replacement without special training. In a case where, for example, lock mechanisms that are configured to be unlocked to allow for detachment are provided to the modules, the addition or replacement of the modules can be easy.

FIG. 1 illustrates an example in which, as examples of the plurality of modules, an armrest module 30, a cushion module 40, a headrest module 50, a light module 60, and a display module 70 are mounted to the vehicle 10. Hereinafter, in a case where not distinguished from each other, these modules are referred to simply as “modules”.

The armrest module 30 is a module in which an armrest and a sensor 31 that detects biological information of a user are integrally formed. Examples of the biological information include a heart rate, a body temperature, or a blood pressure. In the descriptions of the present embodiment, a heart rate is mainly used. That is, the armrest module 30 has a detection function of detecting a heart rate of a user with use of the sensor 31 when an arm of the user is put on the armrest.

The cushion module 40 is a module in which a seat cushion and a vibrator 41 are integrally formed. The cushion module 40 has a massage function of massaging a user seated on the seat cushion by causing the vibrator 41 to vibrate. Note that it is also possible to impart the massage function and the detection function to the cushion module 40 by providing the sensor 31 to the cushion module 40.

The headrest module 50 is a module in which a headrest and a speaker 51 are integrally formed. The headrest module 50 has functions of, for example, notifying the user of various information by sound and providing music.

The light module 60 is a module which is mounted to the ceiling and which is provided with a plurality of light emitting diode (LED) chips 61, which are light emitting elements. The light module 60 has a lighting function of lighting the vehicle interior by controlling luminance and a color outputted by the LED chips 61.

The display module 70 is a module having a display configured to be able to be mounted to the ceiling. The display module 70 has a display function of displaying various information. The display module 70 is mounted at, for example, a position that the user seated on the seat can view.

The user terminal 20 is a device owned by a user who rides the vehicle 10 using a ridesharing service. In the descriptions of the present embodiment, the user terminal 20 is a smart phone. However, the user terminal 20 is not limited to this and may be a tablet terminal or a wearable device.

The user terminal 20 is communicably connected with the armrest module 30, the cushion module 40, the headrest module 50, the light module 60, and the display module 70. The communication scheme used between the user terminal 20 and each of the modules is not particularly limited. For example, the user terminal 20 can communicate with the modules via the Internet in a case where the modules are internet of things (IoT) devices. Alternatively, the user terminal 20 may be connected with the modules via Bluetooth (registered trademark), which is a short-range wireless communication standard.

In the present embodiment, services with use of combinations of the modules are available for the user. The more modules mounted to the vehicle 10 increase the number of the combinations thereof and increase the number of the services available by the combinations. For the user, the increased number of the services available is an increase of options of the services and thus is welcomed. In contrast, the increased number of the services available makes it difficult for the user to grasp which combination can provide which service. In order to address this problem, the present embodiment employs, as an example, a configuration in which the user terminal 20 automatically identifies services available by combinations of the modules and presents the services thus identified to the user.

### (Hardware Configuration of User Terminal 20)

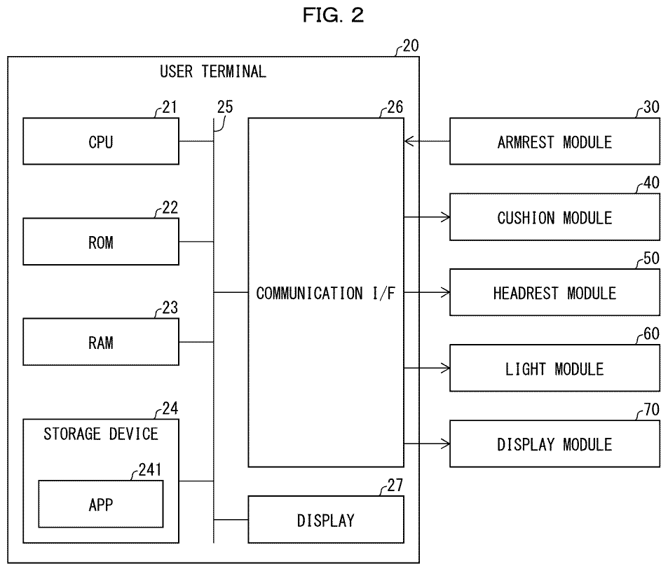

Next, with reference to FIG. 2, the following description will discuss a hardware configuration of the user terminal 20. FIG. 2 is a block diagram illustrating the hardware configuration of the user terminal 20. As illustrated in FIG. 2, the user terminal 20

includes a central processing unit (CPU) 21, a read only memory (ROM) 22, a random access memory (RAM) 23, a storage device 24, a communication I/F 26, and a display 27. The components are communicably connected with each other via a bus 25.

The CPU 21 is a central computation processing unit and is a controller for executing various programs. The CPU 21 reads a program from the ROM 22 or the storage device 24 and executes the program with use of the RAM 23 as a work space. The CPU 21 performs control of the components and various computation processes in accordance with a program stored in the ROM 22 or the storage device 24.

The ROM 22 stores various programs and various data. As a working area, the RAM 23 temporarily stores a program or data.

The storage device 24 is constituted by, for example, a hard disk drive (HDD), a solid state drive (SSD), or a flash memory and stores various program and various data. Specifically, in the storage device 24, an application 241 for controlling the modules mounted to the vehicle is 10 installed. Hereinafter, the application 241 is referred to simply as “app 241”. The CPU 21 reads a dedicated application program from the storage device 24 and executes the application program, so that the app 241 is activated. Further, the storage device 24 stores, as a database, services available by combinations of the modules.

The display 27 is constituted by, for example, a liquid crystal display or an organic EL display and displays various information. Further, the display 27 includes a capacitive touch sensor and functions as an input device that receives a touch operation of the user as an input operation.

The communication I/F 26 is implemented as hardware such as a network adapter, software for communication, or a combination thereof and wirelessly communicates with the modules.

### (Functions of CPU 21)

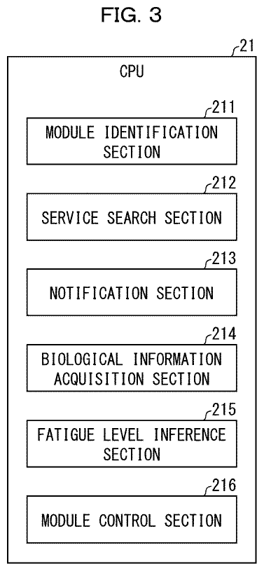

Next, with reference to FIG. 3, the following description will discuss the functions of the CPU 21 of the user terminal 20. FIG. 3 is a functional block diagram illustrating the CPU 21. In the user terminal 20 of the present embodiment, the CPU 21 executes dedicated application programs to function as a module identification section 211, a service search section 212, a notification section 213, a biological information acquisition section 214, a fatigue level inference section 215, and a module control section 216, as illustrated in FIG. 3.

The module identification section 211 automatically identifies the modules mounted to the vehicle 10. For example, the module identification section 211 can receive signals transmitted from the modules and automatically identify which modules are mounted to the vehicle 10. The module identification section 211 outputs information indicative of the modules thus identified to the service search section 212.

The service search section 212 uses the information indicative of the modules acquired from the module identification section 211 to search, with reference to the storage device 24, for services available by combinations of the modules. The service search section 212 outputs the information indicative of the services thus found to the notification section 213. The notification section 213 notifies the user

of the information indicative of the services acquired from the service search section 212 by displaying the information on the display 27.

The biological information acquisition section 214 acquires biological information of the user detected by the module that can detect the biological information of the user. The biological information acquisition section 214 outputs the biological information of the user thus acquired to the fatigue level inference section 215.

The fatigue level inference section 215 infers a level of fatigue of the user on the basis of the biological information of the user acquired from the biological information acquisition section 214. The fatigue level inference section 215 outputs the fatigue level of the user thus inferred to the module control section 216.

The module control section 216 controls the operations of the modules on the basis of the fatigue level of the from the fatigue level inference section 215.

### (Flow of Process Performed by In-vehicle Service Providing System)

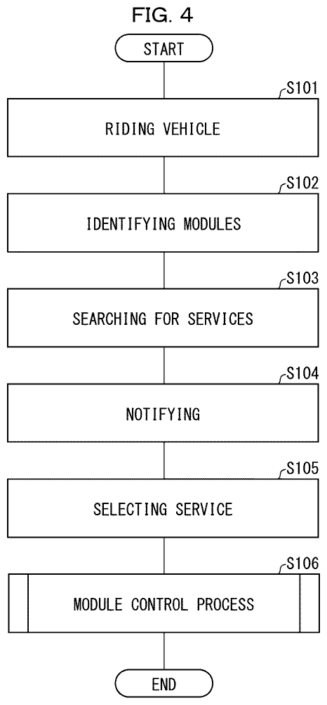

Next, with reference to the flowchart illustrated in FIG. 4, the following description will discuss an example of a flow of the process performed by the in-vehicle service providing system. This process is performed, for example, in a situation where the user rides the vehicle 10 reserved using a ridesharing service.

In the step S101, the user rides the vehicle 10. It is assumed that in this moment, the user rides the vehicle 10 with the app 241 activated.

In the step S102, the CPU 21 of the user terminal 20 automatically identifies modules mounted to the vehicle 10. The modules are each configured to transmit a signal indicating that the module is mounted to the vehicle 10, to the user terminal 20.

Specifically, the armrest module 30 transmits a first signal indicating that the armrest module 30 is mounted to the vehicle 10, to the user terminal 20. If the app 241 is in operation, the user terminal 20 automatically receives the first signal. Reception of the first signal allows the CPU 21 of the user terminal 20 to recognize that the armrest module 30 is mounted to the vehicle 10.

The cushion module 40 transmits a second signal indicating that the cushion module 40 is mounted to the vehicle 10, to the user terminal 20. If the app 241 is in operation, the user terminal 20 automatically receives the second signal. Reception of the second signal allows the CPU 21 of the user terminal 20 to recognize that the cushion module 40 is mounted to the vehicle 10.

The headrest module 50 transmits a third signal indicating that the headrest module 50 is mounted to the vehicle 10, to the user terminal 20. If the app 241 is in operation, the user terminal 20 automatically receives the third signal. Reception of the third signal allows the CPU 21 of the user terminal 20 to recognize that the headrest module 50 is mounted to the vehicle 10.

The light module 60 transmits a fourth signal indicating that the light module 60 is mounted to the vehicle 10, to the user terminal 20. If the app 241 is in operation, the terminal user 20 automatically receives the fourth signal. Reception of the fourth signal allows the CPU 21 of the user terminal 20 to recognize that the light module 60 is mounted to the vehicle 10.

The display module 70 transmits a fifth signal indicating that the display module 70 is mounted to the vehicle 10, to the user terminal 20. If the app 241 is in operation, the user terminal 20 automatically receives the fifth signal. Reception of the fifth signal allows the CPU 21 of the user terminal 20 to recognize that the display module 70 is mounted to the vehicle 10. As such, reception of the first to fifth

signals transmitted by the modules allows the CPU 21 of the user terminal 20 to automatically identify which modules are mounted to the vehicle 10.

The process proceeds to the S103. The CPU 21 of the user terminal 20 refers to the storage device 24 to search for services available by combinations of the modules identified in the process in the step S102.

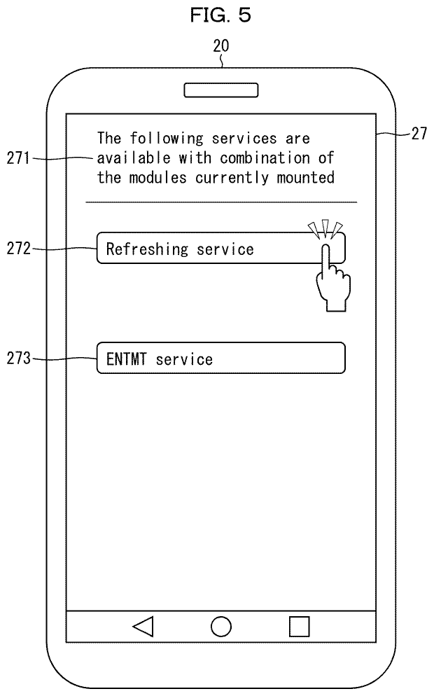

The process proceeds to the step S104. The CPU 21 of the user terminal 20 notifies the user of the services found in the process in the step S103. Here, with reference to FIG. 5, the following description will discuss an example of a method for notifying the user of the services. FIG. 5 illustrates an example of notification displayed on the display 27 of the user terminal 20. This notification is one of the functions of the app 241 and is performed in the app 241.

As illustrated in FIG. 5, the display 27 displays notification 271 that states “the following services are available with combination of the modules currently mounted”. Below the notification 271, the services found in the process in the step S103 are displayed by icons 272 and 273 that can be selected by the user. The icon 272 indicates a refreshing service, and the icon 273 indicates an ENTMT service.

The “refreshing service” is, for example, a service for reducing fatigue of the user. The refreshing service is available by a combination of the armrest module 30, the cushion module 40, the headrest module 50, the light module 60, and the display module 70.

The “ENTMT service” is, for example, a service for providing entertainments, such as films and music. Note that “ENTMT” is an abbreviation of entertainment. The ENTMT service is available by a combination of the headrest module 50 and the display module 70.

The user selects a desired service by touching the icon 272 or the icon 273. It is assumed that in FIG. 5, the user selects the refreshing service by touching the icon 272 (step S105 in FIG. 4).

Turning back to FIG. 4, in the step S106, the CPU 21 of the user terminal 20 receives the selection of the user and controls the modules in order to provide the user with the refreshing service selected by the user.

### (Method for Controlling Modules)

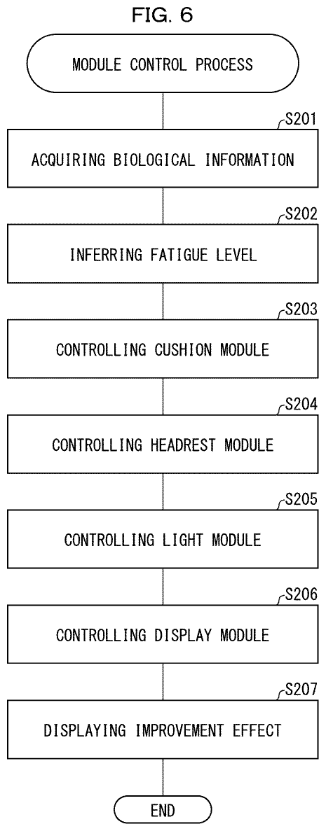

With reference to the flowchart illustrated in FIG. 6, the following description will discuss an example of a method for controlling the modules for providing the refreshing service.

In the step S201, the CPU 21 of the user terminal 20 acquires the biological information of the user from the sensor 31 of the armrest module 30. Specifically, the CPU 21 of the user terminal 20 acquires data on a heart rate of the user from the sensor 31.

The process proceeds to the step S202. The CPU 21 of the user terminal 20 infers the fatigue level of the user with use of the heart rate data of the user acquired in the process in the step S201. The following will describe an example of a method for inferring the fatigue level.

The heart rate is generally represented as the number of heartbeats per minute in terms of beats per minute (BPM). The heart rate in the present embodiment is also treated as the number of heartbeats per minute. Note, however, that the heart rate data detected by the sensor 31 may be data per second instead of the data per minute. There is a tendency that when fatigue sets in, a strong stress causes the sympathetic nervous system to be dominant, resulting in an increase of the heart rate. Therefore, in a case where the heart rate data of the user exceeds a threshold, the fatigue level of the user is inferred to be high. In contrast, in a case where the heart rate data of the user is equal to or less than the threshold, the fatigue level of the user is inferred to be low. As such, the CPU 21 of the user terminal 20 infers the fatigue level of the user. Note that the threshold is set as appropriate, for example, through experiments and simulations. Alternatively, the threshold may be set according to characteristics, such as the sex and the age of the user.

In a case where the fatigue level of the user is inferred to be high, the CPU 21 of the user terminal 20 increases a current caused to flow through the vibrator 41 of the cushion module 40 and performs the massage with the increased vibration level (step S203). In contrast, in a case where the fatigue level of the user is inferred to be low, the CPU 21 of the user terminal 20 decreases a current caused to flow through the vibrator 41 of the cushion module 40 and provides the user with massage with the decreased vibration level (step S203). Such change of the vibration level in accordance with the fatigue level of the user makes it possible to provide the user with massage suitable for the fatigue level of the user. This makes it possible to refresh the user.

Further, the CPU 21 of the user terminal 20 transmits, to the headrest module 50, a control signal for playing healing music and causes the speaker 51 to play the healing music (step S204). The provision of the healing music for the user makes it possible to refresh the user. Note that the CPU 21 of the user terminal 20 may change a type of the healing music from the speaker 51 in accordance with the fatigue level of the user. For example, in a case where the fatigue level of the user is inferred to be high, the CPU 21 may cause the speaker 51 to provide healing music having a more relaxing effect.

Furthermore, the CPU 21 of the user terminal 20 transmits, to the LED chips 61 of the light module 60, a control signal for controlling the luminance and the color and controls the light so as to cause the vehicle interior to turn a warm color (step S205). The light in a warm color has a relaxing effect and thus can refresh the user. Note that the CPU 21 of the user terminal 20 may change the luminance of the LED chips 61 in accordance with the fatigue level of the user. For example, in a case where the fatigue level of the user is inferred to be high, the CPU 21 of the user terminal 20 may reduce the luminance of the LED chips 61.

Furthermore, the CPU 21 of the user terminal 20 transmits, to the display module 70, a control signal for displaying of a relaxing video and causes the display module 70 to display the relaxing video (step S206). The provision of the relaxing video for the user makes it possible to refresh the user. Note that the CPU 21 of the user terminal 20 can change a type of the relaxing video in accordance with the fatigue level of the user. For example, in a case where the fatigue level of the user is inferred to be high, the CPU 21 of the user terminal 20 may cause the display module 70 to display a relaxing video having a more relaxing effect.

Note that the processes in the steps S203 to S206 may be performed at the same timing or may be performed at time intervals. In a case where the processes in the steps S203 to S206 are performed at time intervals, the order of the processes may be changed as appropriate.

In the step S207, the CPU 21 of the user terminal 20 causes the display 27 of the user terminal 20 to display an improvement effect generated by the refreshing service. For example, the CPU 21 of the user terminal 20 causes the display 27 of the user terminal 20 to display a transition between the heart rates before and after the refreshing service. By observing the decrease of the heart rate due to the refreshing service, the user can know that the user was able to be refreshed.

### (Other Services)

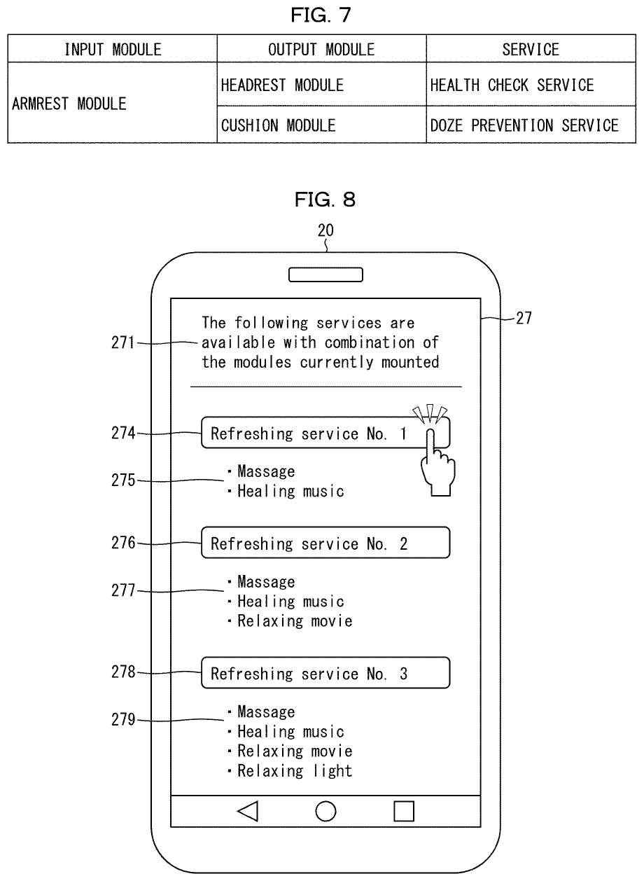

Services available for the user are not limited to the refreshing service and the ENTMT service. Examples of other services include a health check service and a doze prevention service, as illustrated in FIG. 7.

The health check service is a service available by a combination of the armrest module 30 and the headrest module 50. The health check service is, for example, a service of notifying, through the speaker 51 of the headrest module 50, a user of a health condition (for example, irregular heart beat) diagnosed on the basis of the heart rate data detected by the sensor 31 of the armrest module 30. This allows the user to know the health condition of the user.

The doze prevention service is a service available by a combination of the armrest module 30 and the cushion module 40. The doze prevention service is, for example, a service of eliminating sleepiness of the user by causing the vibrator 41 of the cushion module 40 to vibrate in a case where sleepiness of the user is detected on the basis of the heart rate data detected by the sensor 31 of the armrest module 30. This makes it possible to prevent the doze of the user.

An “input module” illustrated in FIG. 7 refers to a module having a function of transmitting certain data detected to the user terminal 20. An “output module” is a module that is configured to perform certain output in response to an instruction from the user terminal 20. The armrest module 30 is classified as the input module, since having a function of transmitting biological information of the user detected, to the user terminal 20. Each of the headrest module 50 and the cushion module 40 is classified as the output module, since being configured to perform certain output in response to the instruction from the user terminal 20.

### (Other Combinations for Refreshing Service)

In the above description, the refreshing service is a service that is available by a combination of the armrest module 30, the cushion module 40, the headrest module 50, the light module 60, and the display module 70. Note, however, that the refreshing service is not limited to this combination. For example, the refreshing service may be provided by a combination of the cushion module 40 and the headrest module 50.

Alternatively, the refreshing service may be provided by a combination of the cushion module 40, the headrest module 50, and the display module 70. Still alternatively, the refreshing service may be provided by a combination of the cushion module 40, the headrest module 50, the display module 70, and the light module 60.

In a case where the refreshing service is provided by such a combination, the service contents are notified on the display 27 of the user terminal 20, for example, as illustrated in FIG. 8. FIG. 8 is a view illustrating other combinations for refreshing services. An icon 274 indicates a “refreshing service No. 1”, which is one of refreshing services and can be selected by the user. Below the icon 274, notification 275 showing the contents of the “refreshing service No. 1” is displayed. The “refreshing service No. 1” is a service name of a refreshing service provided by a combination of the cushion module 40 and the headrest module 50. Therefore, the service contents of the “refreshing service No. 1” are, as illustrated in the notification 275, massage provided by the cushion module 40 and healing music provided by the headrest module 50.

An icon 276 indicates a “refreshing service No. 2”, which is one of refreshing services and can be selected by the user. Below the icon 276, notification 277 showing the contents of the “refreshing service No. 2” is displayed. The “refreshing service No. 2” is a service name of a refreshing service provided by a combination of the cushion module 40, the headrest module 50, and the display module 70. Therefore, the service contents of the “refreshing service No. 2” are, as illustrated in the notification 277, massage provided by the cushion module 40, healing music provided by the headrest module 50, and a relaxing video provided by the display module 70.

An icon 278 indicates a “refreshing service No. 3”, which is one of refreshing services and can be selected by the user. Below the icon 278, notification 279 showing the contents of the “refreshing service No. 3” is displayed. The “refreshing service No. 3” is a service name of a refreshing service provided by a combination of the cushion module 40, the headrest module 50, the display module 70, and the light module 60. Therefore, the service contents of the “refreshing service No. 3” are, as illustrated in the notification 279, massage provided by the cushion module 40, healing music provided by the headrest module 50, a relaxing video provided by the display module 70, and relaxing light provided by the light module 60.

By touching the icon 274, 276, or 278, the user can select a desired service among services provided by a variety of combinations of the modules. Note that in the refreshing services Nos. 1 to 3 illustrated in FIG. 8, the armrest module 30 is not used. This means that the “input module” described in FIG. 7 is not essential when the service is provided. That is, when the refreshing service is provided, the consideration of the fatigue level of the user is not essential, and it is possible to provide the refreshing service irrespective of the fatigue level of the user. In this case, the CPU 21 of the user terminal 20 can, for example, control the vibrator 41 of the cushion module 40 and control the LED chips 61 of the light module 60 on the basis of the predetermined contents.

### Variation of Embodiment 1

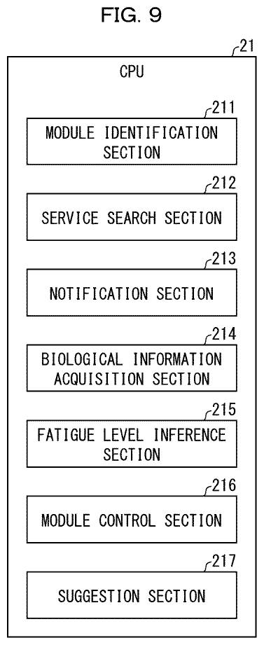

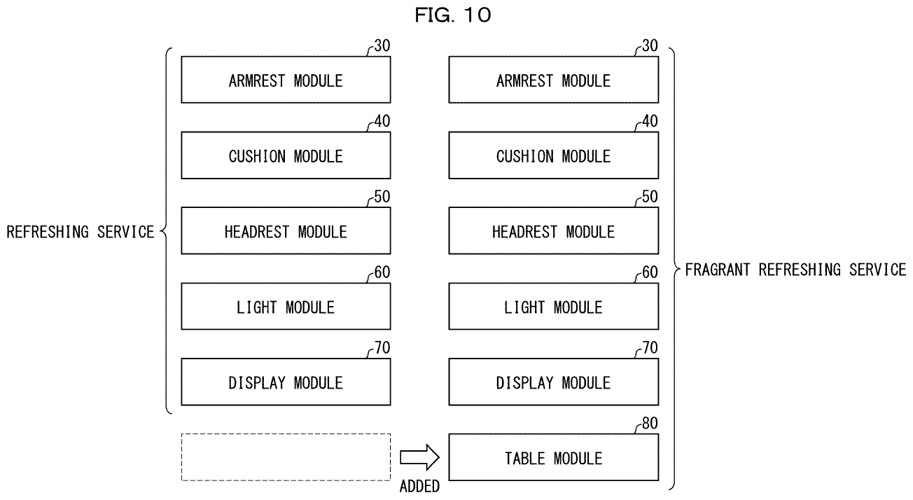

With reference to FIGS. 9 and 10, the following description will discuss a variation of the Embodiment 1.

FIG. 9 is a functional block diagram illustrating the CPU 21 of the user terminal 20, in accordance with a variation. As illustrated in FIG. 9, the CPU 21 of the user terminal 20, in accordance with the variation functions further as a suggestion section 217 by executing a dedicated application program.

The suggestion section 217 suggests, to the user, a service that becomes available by mounting a new module in addition to the modules mounted to the vehicle 10. Specifically, the suggestion section 217 accesses an external server to acquire information on new modules that can be mounted to the vehicle 10 in addition to the modules mounted in the vehicle 10 and to acquire information on services that become available by adding the new modules.

FIG. 10 is a view illustrating a service that becomes available by adding a new module. As illustrated in FIG. 10, before a table module 80 which is the new module is added, the refreshing service is available with use of the combination of the armrest module 30, the cushion module 40, the headrest module 50, the light module 60, and the display module 70, as described above.

The table module 80 which is the new module is a module having a table form in which a table on which a thing can be placed and an instrument configured to diffuse scent in the vehicle interior, which is typified by an aroma diffuser, are integrally formed. The table module 80 is combined further with the armrest module 30, the cushion module 40, the headrest module 50, the light module 60, and the display module 70, so that a “fragrant refreshing service” which is a new service becomes available. The suggestion section 217 suggests the fragrant refreshing service which is a new service, to the user. The method for the suggestion is not particularly limited. For example, the suggestion may be performed through notification in the app 241 or may be performed through notification by e-mail to the user.

For example, in a case where the user owns a private vehicle, such suggestion leads to an increase of motive for buying a new module. This is because buying a new module allows the user to receive a new service.

Further, the suggestion section 217 may suggest, to the owner who owns the vehicle 10, that combining a new module causes a new service to be available. Buying a new module allows the owner to emphasize that a new service is available, to users of a ridesharing service. This appeal contributes to attracting customers. Therefore, such suggestion leads to an increase of motive for buying a new module.

Note that the above-described health check service is available by a single module, for example, in a case where the speaker 51 is integrally formed in the armrest module 30. This is because the health condition diagnosed on the basis of the heart rate data detected by the sensor 31 can be notified to the user through the speaker 51. In addition, the above-described refreshing service is available by a single module, for example, in a case where the sensor 31 is integrally formed in the cushion module 40. This is because massage can be provided for the user by causing the vibrator 41 to vibrate in accordance with the fatigue level inferred on the basis of the heart rate data detected by the sensor 31.

### (Effects)

As described above, Embodiment 1 can give the following effects.

The user terminal 20 which is an information processing device is communicably connected with at least one module that is detachably mounted to the vehicle 10. The user terminal 20 presents, to the user of the vehicle 10, a service that is available by the at least one module.

The module is easily attached to and easily detached from the vehicle 10, and thus a variety of modules can be attached to the vehicle 10. Presenting services available by the modules attached leads to provision of a variety of services.

In addition, the at least one module may be detachably mounted to the vehicle 10 and has a function which is able to be, while the module is mounted to the vehicle 10, activated and deactivated depending on whether or not the module is energized.

In addition, the user terminal 20 may present, to the user, a service available by a combination of the plurality of modules.

According to the above configuration, it is possible for the user to easily grasp which combination of the modules can provide which service.

The at least one module currently mounted to the vehicle 10 is referred to as a first module. At least one module that is currently unmounted to the vehicle 10 is referred to as a second module. In a case where there is a service that, when the second module is mounted to the vehicle 10, becomes available by a combination of the first module and the second module, the user terminal 20 may present the service to the user.

A new service that the user can receive when the user buys a new module leads to an increase of motive for buying the new module. Note that a plurality of first modules and a plurality of second modules may be provided.

The plurality of modules may include at least one module that acquires biological information of the user.

According to the above configuration, it is possible to provide the user with a service suitable for the biological information of the user. Note that an example of the module that acquires the biological information of the user is the input module illustrated in FIG. 7.

### Embodiment 2

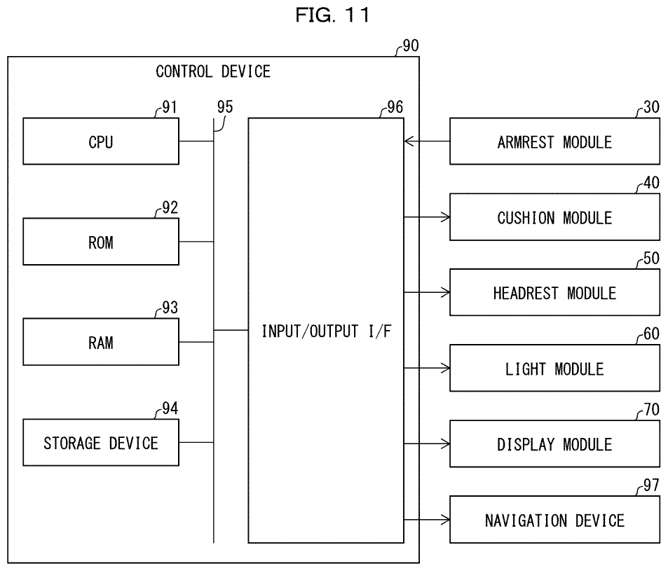

Next, with reference to FIG. 11, the following description will discuss Embodiment 2. Embodiment 2 differs from Embodiment 1 in that a subject which communicates with and controls the modules is not the user terminal 20 but a control device 90 mounted to the vehicle 10. The following description is centered on the difference point.

### (Hardware Configuration of Control Device 90)

FIG. 11 is a block diagram illustrating a hardware configuration of the control device 90. As illustrated in FIG. 11, the control device 90 includes a CPU 91, a ROM 92, a RAM 93, a storage device 94, and an input/output I/F 96. The components are communicably connected with each other via a bus 95. The CPU 91, the ROM 92, the RAM 93, and the storage device 94 are respectively the same as the CPU 21, the ROM 22, the RAM 23, and the storage device 24 which are described with reference to FIG. 2, and thus descriptions thereof are omitted.

The input/output I/F 96 is an interface for communicating with the modules. As this interface, for example, a communication standard constituted by a controller area network (CAN) protocol is used. Note that the modules may be directly connected with the bus 95.

As in the case of the CPU 21 of the user terminal 20, the CPU 91 of the control device 90 has functions of, for example, identifying the modules and presenting, to user, the services available by combinations of the modules. The presentation of the services to the user can be achieved by, for example, displaying, on a display of a navigation device 97, the contents similar to those on the display illustrated in FIG. 5.

Advantages of controlling the modules with use of the control device 90 instead of the user terminal 20 are, for example, that it becomes unnecessary for a user to install the app 241 into the user terminal 20 and that users who do not own the user terminals 20 can use the services. Further, use of the existing CAN protocol makes it easy to perform communication with and control of the modules.

### Embodiment 3

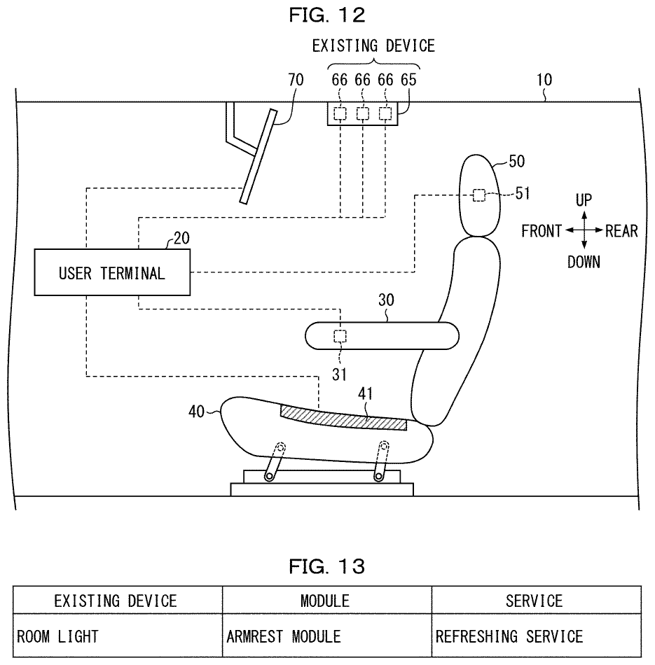

Next, with reference to FIGS. 12 and 13, the following will discuss Embodiment 3. Embodiment 3 differs from Embodiment 1 in that services available by combinations of an existing device and modules are presented to the user. The following description is centered on the difference point.

In Embodiment 1, the services available by combinations of the modules are presented to the user. In Embodiment 3, services available by combinations of an existing device and modules, instead of the combination of the modules are presented to the user.

The “existing device” in Embodiment 3 refers to a device that is mounted to the vehicle 10 in advance. More specifically, the existing device may be defined as a device that is mounted to the vehicle 10 at the time point of the delivery of the vehicle 10. Alternatively, the existing device may be defined as a device that is normally not assumed to be replaced except for the replacement due to, for example, malfunction or the operation life.

FIG. 12 is a view schematically illustrating a configuration of an in-vehicle service providing system in accordance with Embodiment 3. In FIG. 12, a room light 65 having LED chips 66 is the existing device. Thus, in FIG. 12, the four modules (an armrest module 30, a cushion module 40, a headrest module 50, and a display module 70) and the room light 65, which is the existing device, are mounted to the vehicle 10.

In Embodiment 3, the user terminal 20 is communicably connected not only with the modules but also with the existing device. That is, the user terminal 20 is communicably connected also with the room light 65, which is the existing device. The user terminal 20 can, for example, identify that the room light 65 is the existing device and control the LED chips 66 to adjust the light emitted from the room light 65. Note that the identification of whether or not the room light 65 is the existing device is achieved by, for example, the user terminal 20 receiving, from the room light 65, an identification signal indicating that the room light 65 is the existing device.

Services available by combinations of the room light 65, which is the existing device, and the modules are stored in the storage device 24. The user terminal 20 refers to the storage device 24 to search for the services available by the combinations of the room light 65 and the modules. The user terminal 20 presents the services obtained through the search to the user.

FIG. 13 is a view illustrating one example of the services available by the combinations of the existing device and the modules. As illustrated in FIG. 13, a refreshing service is available by a combination of the room light 65, which is the existing device, and the armrest module 30. The refreshing service allows the user to be refreshed, by changing the light in accordance with a fatigue level of the user.

The user terminal 20 which is an information processing device presents, to the user, services available by combinations of the existing device mounted to the vehicle 10 in advance and the modules. According to the above configuration, it is possible to provide a variety of services for the user.

Note that the user terminal 20 may present, to the user, a service available by a combination of at least one existing device and at least one module. Alternatively, the user terminal 20 may present, to the user, a service available by a combination of a plurality of existing devices and at least one module.

Alternatively, the user terminal 20 may present, to the user, a service available by a combination of at least one existing device and a plurality of modules. Alternatively, the user terminal 20 may present, to the user, a service available by a combination of a plurality of existing devices and a plurality of modules. [Software Implementation Example]

The functions of the user terminal 20 and the control device 90 can be realized by a program for causing a computer to function as the user terminal 20 and the control device 90, the program causing the computer to function as each control block of the user terminal 20 or the control device 90.

In this case, the user terminal 20 or the control device 90 includes, as hardware for executing the program, a computer which includes at least one device (e.g., processor) and at least one storage device (e.g., memory). Each function described in the foregoing embodiments can be realized by the computer executing the program.

The program may be stored in one or more non-transitory computer-readable storage media. These storage media may or may not be provided in the user terminal 20 or the control device 90. In the latter case, the program can be supplied to or made available to the user terminal 20 or the control device 90 via any transmission medium such as a wired transmission medium or a wireless transmission medium.

Further, some or all of functions of the control blocks can be realized by a logic circuit. For example, the present disclosure encompasses, in its scope, an integrated circuit in which a logic circuit that functions as each of the control blocks is formed. As another alternative, for example, it is possible to realize the functions of the control blocks by a quantum computer.

Further, each of the processes which are described in the foregoing embodiments may be carried out by artificial intelligence (AI). In this case, the AI may be operated by the user terminal 20 or the control device 90, or alternatively operated by another device (e.g., an edge computer, a cloud server, or the like).

The present disclosure is not limited to the embodiments above, but can be altered by a skilled person in the art within the scope of the claims. The present disclosure also encompasses, in its technical scope, any embodiment derived by combining technical means disclosed in differing embodiments as appropriate.

Embodiment 1 above describes the configuration in which when or after the user rides the vehicle 10, the user terminal 20 owned by the user identifies the module mounted to the vehicle 10 and presents the services with use of the combinations of the modules, to the user. The present disclosure is not limited to this configuration. For example, a configuration is also possible in which when the user reserves the vehicle 10 using a ridesharing service, the user terminal 20 identifies the modules mounted to the vehicle 10 and presents the services with use of the combinations of the modules, to the user. This makes it possible for the user to know the services available when the user reserves the vehicle 10. Note that, as a method for identifying the modules mounted to the vehicle 10 when the vehicle 10 is reserved, a method is possible in which the user terminal 20 identifies the modules via the Internet if the modules are IoT devices.

When the modules mounted to the vehicle 10 are identified, the CPU 21 of the user terminal 20 or the CPU 91 of the control device 90 may cause the modules to function by causing the modules to be energized. In this case, if an arrangement is employed in which the user can receive a paid service by paying money to cause predetermined modules to be energized to cause the modules to function, the user can receive a new service without buying a new module. Note that the expression “the function is able to be activated and deactivated depending on whether or not the module is energized” means that, for example, taking the armrest module 30 as an example, when the armrest module 30 is energized, the function of detecting a heart rate is activated, whereas when the armrest module 30 is not energized, the function of detecting a heart rate is deactivated.
5 Reference Signs List
10 Vehicle
20 User terminal
30 Armrest module
40 Cushion module
50 Headrest module
60 Light module
70 Display module
80 Table module
90 Control device

1. An information processing device comprising controller,
the controller being communicably connected with at least one module that is detachably mounted to a vehicle or that is detachably mounted to the vehicle and has a function which is able to be, while the at least one module is mounted to the vehicle, activated and deactivated depending on whether or not the at least one module is energized,
the controller being configured to present, to a user of the vehicle, a service available by the at least one module.

2. The information processing device according to claim 1, wherein:
the at least one module includes a plurality of modules; and
the controller presents, to the user, a service available by a combination of the plurality of modules.

3. The information processing device according to claim 1, wherein the controller presents, to the user, a service available by a combination of a device mounted to the vehicle in advance and the at least one module.

4. The information processing device according to claim 1, wherein:
the at least one module is a first module mounted to the vehicle; and
in a case where there is a service that, when at least one second module which is currently unmounted to the vehicle is mounted, becomes available by a combination of the first module and the at least one second module, the controller presents, to the user, the service that becomes available by the combination.

5. The information processing device according to claim 2, wherein the plurality of modules include at least one module that acquires biological information of the user.

6. An information processing method used for an information processing device including a controller,
the controller being communicably connected with at least one module that is detachably mounted to a vehicle or that is detachably mounted to the vehicle and has a function which is able to be, while the at least one module is mounted to the vehicle, activated and deactivated depending on whether or not the at least one module is energized,
the method comprising presenting, to a user of the vehicle, a service available by the at least one module.

7. An information processing system comprising:
an information processing device including a controller; and
at least one module that is detachably mounted to a vehicle or that is detachably mounted to the vehicle and has a function which is able to be, while the at least one module is mounted to the vehicle, activated and deactivated depending on whether or not the at least one module is energized,
the controller being communicably connected with the at least one module,
the controller being configured to present, to a user of the vehicle, a service available by the at least one module.
